(19) United States
(12) Patent Application Publication
(10) Pub. No.: US 2003/0231861 A1
(43) Pub. Date: Dec. 18, 2003

(54) System and method for playing content information using an interactive disc player

(75) Inventors: Jea Yong Yoo, Seoul (KR); Tae Ho Kim, Seoul (KR); Woo Seong Yoon, Kyonggi-do (KR); Limonov Alexandre, Seoul (KR); Yong Cheon Kim, Seoul (KR)

Correspondence Address: JONATHAN Y. KANG, ESQ., LEE & HONG P.C., 14th Floor, 801 S. Figueroa Street, Los Angeles, CA, 90017-5554, US

(73) Assignee: LG Electronics Inc.

(21) Appl. No.: 10/463,758

(22) Filed: Jun. 17, 2003

(30) Foreign Application Priority Data
Jun. 18, 2002 (KR) 2002-34154

(51) Int. Cl. H04N 5/76; H04N 5/91; H04N 7/00; H04N 7/26

(52) U.S. Cl. 386/46; 386/111

(57) ABSTRACT

A method of playing interactive content information using a content disk player is provided. The method comprises retrieving playback time information of first content information recorded on a recording medium playable in a content disk player; transmitting the playback time information to a content server in communication with the content disk player via a communication network; receiving second content information corresponding to the first content information from the content server; and playing back the second content information along with the first content information, based on said playback time information.

### CROSS-REFERENCE TO RELATED APPLICATION

Pursuant to 35 U.S.C. § 119(a), this application claims the benefit of earlier filing date and right of priority to the Korean Patent Application No. 10-2002-34154, filed on Jun. 18, 2002, the content of which is hereby incorporated by reference in its entirety.

### BACKGROUND OF THE INVENTION

1. Field of the Invention

The present invention relates to a content information playing method using an Interactive Digital Versatile Disc (I-DVD) player, and a content information providing method for playing back various content information that is related with A/V data stored an optical disc, such as an I-DVD.

2. Related Art

A high-density optical disk (e.g., a DVD) has very large storage capacity for digital data. The storage capacity of a DVD is sufficient to record high-quality motion picture data of relatively long duration as well as high-quality audio data.

A DVD has two recording areas, one for actual data (e.g., audiovisual or A/V data) and another for control or navigation data used for reproduction control of the recorded actual data. When a DVD is placed into a DVD player, the navigation data is read into a memory first, and then actual data (A/V data) is reproduced with reference to the instructions or control information included in the navigation data. As a result, a user can view a high quality motion picture stored on a DVD using a DVD player.

Recently, an interactive or enhanced navigation (i.e., “I-DVD” or “ENAV”) system has been proposed. An interactive content medium, such as a content disk (e.g., I-DVD or ENAV disk), can comprise control, navigation or A/V data in form of ‘html’ (Hyper-Text Markup Language) or ‘xml’ (EXtensible Markup Language) files. The control data allows an interactive reproduction device (e.g., I-DVD or ENAV player) to reproduce A/V data in accordance with the control and navigation data stored on the interactive content disk.

Throughout this document the terms “I-DVD” and “ENAV” are used interchangeably to refer to an interactive or enhanced navigation system. For simplicity and consistency, the term I-DVD will be used, hereinafter.

Generally, a high-density optical disc, such as DVD, that can store large volume of digital data is widely distributed. The DVD is commercialized as a recording medium of large volume that can store many hours of digital audio data as well as high quality video data.

Meanwhile, the DVD is comprised of navigation data recording field where navigation data for playback controlling of the video data; and data stream recording field where digital data stream, such as the video data, is recorded and stored.

Therefore, in a case where the DVD is inserted in a typical DVD player, the DVD player performs DVD play-back operation that extracts and playbacks video data that is recorded in the data stream recording field, by using the navigation data after recording the extracted navigation data, that is recorded in the navigation data-recording field, into memory in the apparatus. Hence, a user who has the DVD player can watch many hours of high quality video data that is recorded in the DVD, and select various functions provided in the DVD as well.

Recently, the related industries are discussing plans for recording A/V data, extracted and played from the DVD, and the related information as contents information, such as HTML file, and also discussing for materializing I-DVD that extracts and plays through an interface with a user. When the I-DVD of such kind becomes commercialized, the user is expected to be able to easily search for detailed information that relates to the A/V data.

Unfortunately, specific plans for playback of both A/V data and various related content information available through a content server are not implemented. Methods and systems that can address the above problem are needed.

### SUMMARY OF THE INVENTION

It is an object of the present invention to provide a method for enabling output playback of various content information communicated through an interface between an I-DVD player and a content server.

In accordance with one embodiment, a method of playing interactive content information using an I-DVD player, the method comprises retrieving playback time information of first content information recorded on a recording medium playable in an I-DVD player; transmitting the playback time information to a content server in communication with the I-DVD player via a communication network; receiving second content information corresponding to the first content information from the content server; and playing back the second content information along with the first content information, based on said playback time information.

The playback time information is a presentation time stamp that indicates the play start time of the first content information. In some embodiments, playback time information is a presentation time stamp that is earlier than the play start time of the first content information by a predetermine period. The predetermined time period is approximately equal to length of time needed to receive the second content information from the content server.

In one embodiment, the second content information comprises advertising information associated with the first content information. The second content information is received from the content server at predetermined time intervals. In an alternative embodiment, the second content information is received from the content server in real-time in accordance with the playback time information associated with the first content information.

A content information playback method for a content server in communication with at least one I-DVD player connected to a communications network is also provided. The method comprising determining playback time for first content information, said playback time received from an I-DVD player; retrieving second content information associated with the first content information; and transmitting the second content information to the I-DVD player for playback in association with the first content information.

The step of determining a playback time comprises receiving a presentation time stamp (PTS) from the I-DVD player, wherein the PTS indicates time when playback of the first content information starts. In some embodiments, the first content information comprises audio/visual (A/V) data recorded on a recording medium readable by the I-DVD player.

In accordance to another embodiment, a system for playback of media content information using an I-DVD player connected to a content server via a communications network, comprises means for accessing a database over the communications network, wherein the database comprises access information about location of auxiliary content associated with the media content played by the I-DVD player; and means for transmitting the auxiliary content to the I-DVD player so that the auxiliary content can be played along with the media content; wherein said access information is obtained based on at least one of a disk ID and a content version associated with a recording medium containing the media content.

In one embodiment, the auxiliary content is stored on the content server. The access information may be a Uniform Resource Locator (URL), for example, identifying the content server. In some embodiments, at least one of the disk ID and the content version are transmitted from the I-DVD player to the content server, so that the content server can determine the auxiliary content associated with the media content based on corresponding information included in the database.

In one or more embodiments, the database comprises an association between a plurality of disk Ids and content versions, such that each disk Id in association with a content version corresponds to auxiliary content for the respective content version. Certain embodiments also comprise means for transmitting a presentation time stamp to the content server, wherein the presentation time stamp is recorded in the recording medium.

The presentation time stamp represents approximate time when the I-DVD player starts playback of the media content. Alternatively, the presentation time stamp may represent approximate time needed to download the auxiliary data in advance of time when playback of the media content starts. The time stamp is transmitted embedded in a header of a communication packet.

In accordance with yet another embodiment, an I-DVD system for playback of media content comprises means for accessing a content server comprising auxiliary content associated with the media content recorded on a recording medium readable by an I-DVD player; means for transmitting identification information to retrieve said auxiliary content from the content server; means for receiving the auxiliary content from the content server; and means for playing the auxiliary content along with the media content in accordance with a presentation time stamp. The system may also comprise means for transmitting the presentation time stamp to the content server to ensure timely receipt of the auxiliary content prior to time when playback of the media content starts.

In a certain embodiment, a content server system for providing auxiliary content recorded on the content server for playback with media content recorded on a recording medium readable by an I-DVD player comprises means for receiving identification information associated with the auxiliary content from the I-DVD player over a communications network; and means for transmitting the auxiliary content to the I-DVD player; wherein the I-DVD player plays back the auxiliary content along with the media content, in accordance with a presentation time stamp.

In some embodiments the system further comprises means for receiving the presentation time stamp from the I-DVD player, the presentation time stamp indicating time when the I-DVD player starts playing the media content; and means for transmitting the auxiliary content to the I-DVD in a timely fashion, so that the I-DVD player starts playing the auxiliary content along with the media content.

It is to be understood that both the foregoing general description and the following detailed description are exemplary and explanatory and are intended to provide a further explanation of the invention as claimed.

### BRIEF DESCRIPTION OF THE DRAWINGS

The accompanying drawings, which are included to provide further understanding of the invention, illustrate the preferred embodiments of the invention, and together with the description, serve to explain the principles of the present invention.

FIG. 1 illustrates a block diagram of an I-DVD player, in accordance with one embodiment of the invention;

FIG. 2 is an illustration of the directory structure of an I-DVD, in accordance with one embodiment of the invention;

FIG. 3 illustrates access status of a number of I-DVD players connected to a content server, in accordance with one embodiment of the invention;

FIG. 4 is an exemplary table with content information recorded and stored in database of a content server, in accordance with one embodiment of the invention;

FIG. 5 illustrates a method of communication of content information between an I-DVD player and a content server, in accordance with one embodiment of the present invention; and

FIG. 6 illustrates an exemplary communication packet comprising a presentation time stamp, in accordance with one embodiment of the invention.

Features, elements, and aspects of the invention that are referenced by the same numerals in different figures represent the same, equivalent, or similar features, elements, or aspects in accordance with one or more embodiments.

### DETAILED DESCRIPTION OF THE PREFERRED EMBODIMENTS

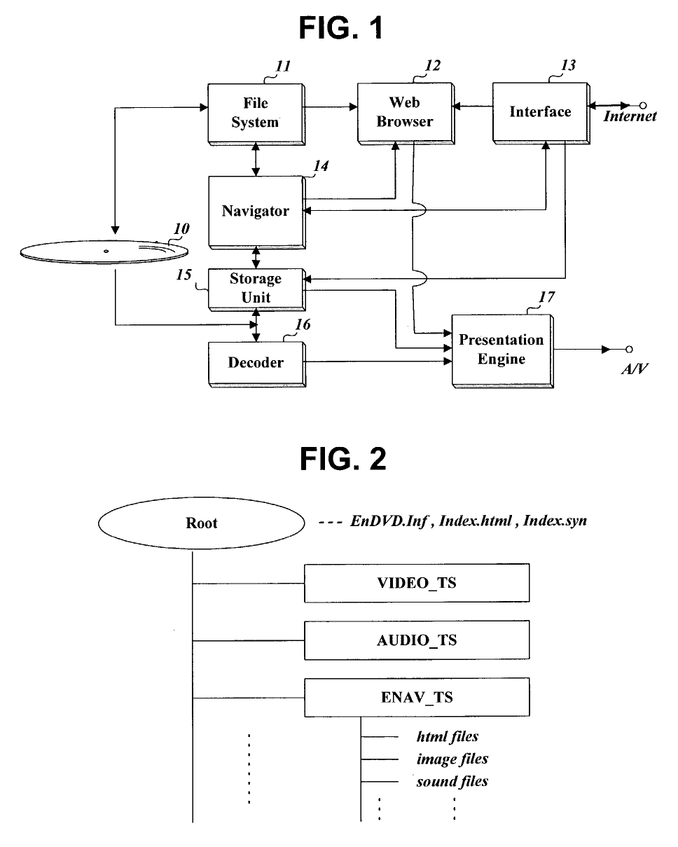

Referring to FIG. 1, the system of the present invention, in accordance with one embodiment, is implemented to reproduce audiovisual (A/V) data stored on a content disk 10. A/V data may comprise DVD video data, image data, audio data, text, or other forms of information. The content disk 10 in addition to A/V data may contain enhanced navigation (ENAV) or control data to provide an interactive reproduction device (e.g., ENAV player or I-DVD player) with instruction on how to reproduce the A/V data or to provide additional information to be played with the A/V data. Hereinafter, the terms ENAV or I-DVD are used interchangeably and shall refer to an interactive DVD system.

Please note that, for the purpose of simplicity and efficiency, throughout the application, the system of the present invention has been described in association with an “I-DVD” disk or “I-DVD” player. This association, however, is by way of example and should not be construed as limiting the invention to the particular embodiments disclosed. As such, alternative recording mediums or players are within the scope of the invention.

An I-DVD player, in accordance with one or more embodiments of the invention, comprises a DVD reproduction engine and an enhanced navigation or interactive (I-DVD) reproduction engine. The DVD reproduction engine is utilized in association with the I-DVD reproduction engine to reproduce A/V data stored on the I-DVD disk, in accordance with the enhanced navigation data stored on the I-DVD disk.

In some embodiments, the I-DVD engine of the system comprises a file system 11, a web browser 12, an interface 13, a navigator 14, a storage unit 15, a decoder 16, a presentation engine 17, and a controller (not shown). The web browser 12 and interface 13 provide network management services for connecting the I-DVD player to a communication network such as the Internet, and also to support enhanced user interface and to handle user interaction with the system. The file system 11 and navigator 14 act together to load, parse, and interpret digital data loaded from disk 10 for decoding purposes. The controller is utilized to process enhanced navigation data and the interface between the DVD engine and the I-DVD engine, and to control the system elements in response to a user request, for example.

The decoder 16 is utilized for decoding digital data read from disk 10, for example. The presentation engine 17 processes decoded A/V data to provide an A/V output to a display terminal, for example. File system 11 is provided for conducting file management (e.g., searching and reading recorded files, such as a disk information file, a setup file, and a sync data file), for example. Web browser 12 includes a web surfing function and is able to set up presentation environment for reproduction of A/V data, for example.

Storage unit 15 may be any type of data storage medium such as flash memory or a hard drive for storing files uploaded from disk 10 or files downloaded from a communication network to which the system is connected. Storage unit 15 can be cache memory or a buffer for temporary storage of information, for example, and may be implemented in RAM, ROM, EEPROM, a hard disk or other type of storage medium.

The navigator 14, the file system 11, and the web browser 12 represent logical units and may be implemented in form of software, hardware, or a combination of the two. In some embodiments, some or all of the logical units and components illustrated in FIG. 1 may be implemented in one or more integrated logic chips such as Field Programmable Gate Arrays (FPGAs) or Application Specific Integrated Circuits (ASICs).

Referring to FIG. 2, in accordance with one or more embodiments of the system, one or more data and/or control files exist or can be implemented under a root directory of the I-DVD disk. A DVD enhanced navigation directory (i.e., DVD_ENAV or ENV_TS) directory may exist, for example, directly under the root directory as shown in FIG. 2. Files including enhanced navigation or other control information and enhanced navigation content files may be placed under the DVD enhanced navigation directory. These files may include html, xml, and A/V content, for example.

In some embodiments, a first file ‘EnDVD.Inf’, for example, comprises information for reproduction of A/V data recorded on an I-DVD disk 10, a second file ‘Index.html’, for example, comprises information relating to initial setup for reproduction of A/V data, and a third file ‘Index.syn’, for example, comprises time information for synchronizing between A/V data and additional data provided through the communication network or a user.

In some embodiments, under the root directory, other subdirectories may be implemented. A directory ‘VIDEO_TS’, for example, may comprise files of video data. Another directory ‘AUDIO_TS’, for example, may comprise files of audio data, and a subsequent directory ‘ENAV_TS’, for example, may comprise additional content files (e.g., ‘html’ files, ‘xml’ files, image files, video and audio files).

In one embodiment, the file ‘EnDVD.Inf’, for example, under the root directory comprises information about a disk version, a content version, a content manufacturer, or a reference address (e.g., URL) for accessing a remote content provider. The remote content provider may provide a variety of contents and content-related information provided by other users connected to the same communication network or new update information that correspond with the A/V data being reproduced at a certain time interval.

The setup file ‘Index.html’, for example, under the root directory may comprise environment setup information for the web browser 12 and control or navigation information for reproduction of the content stored on I-DVD disk 10. The file ‘Index.syn’, for example, may comprise time stamp data to synchronize A/V data read from the I-DVD disk 10 with other contents down loaded from a remote content provider, for example.

In some embodiments, the directory ‘ENAV_TS’, for example, comprises additional contents to be reproduced or outputted in synchronization with A/V data. Additional contents provided from a remote content provider may be also stored under the directory ‘ENAV_TS’, for example. The additional contents may comprise html or xml files, image files, sound files, and video files, for example. It is noteworthy that the file and directory names and the particular data structures disclosed here with reference to the A/V and enhanced navigation data are for the purpose of example. As such, other names and different or equivalent directory structures and formats may be implemented or used that would accomplish the objectives of the present invention in the same manner to perform the same function and to obtain the same results, without limiting the scope of the invention.

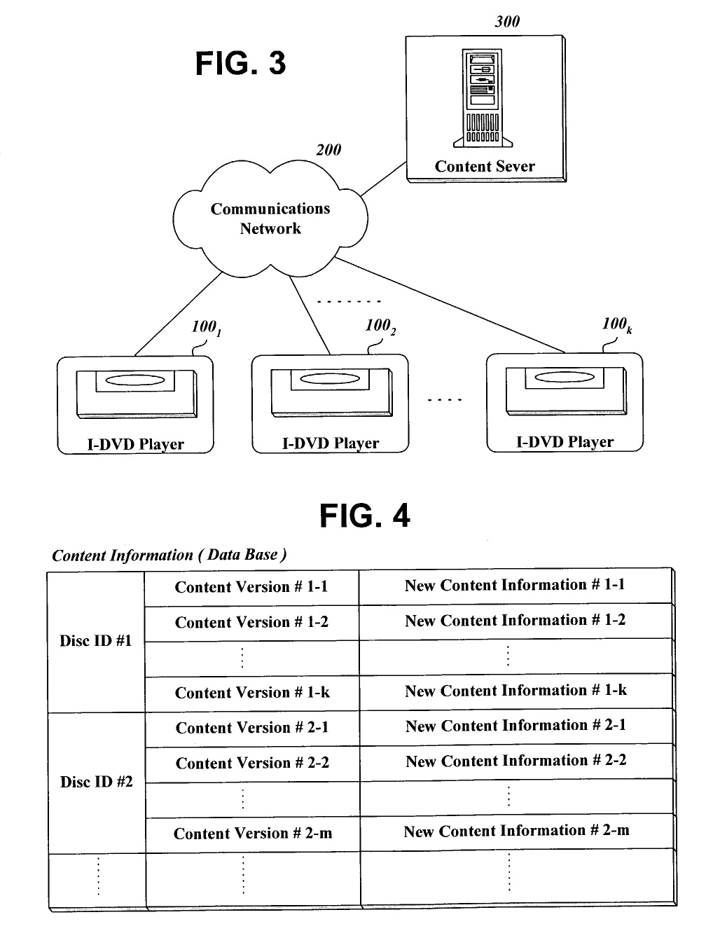

Referring to FIG. 3, the content server 300 can be connected to a number of I-DVD players 100₁˜100ₖ via the internet, for example. The content server 300 may comprise content information stored in a data base or other data structure, for example. The data base, in one embodiment, may comprise one or more Disc IDs, one or more content version information, and at least one content information associated with each content version information.

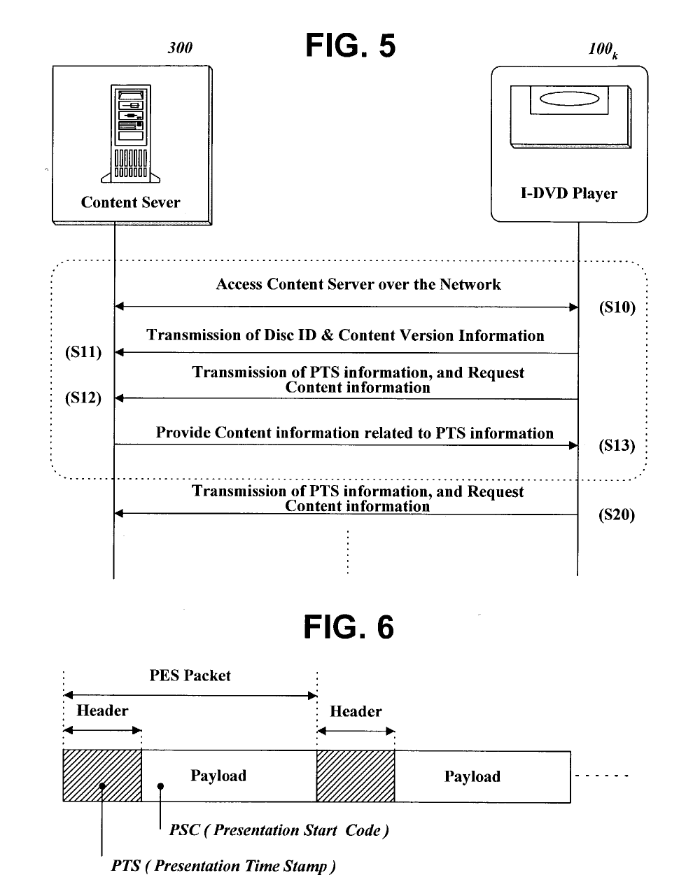

The content server 300 can transmit various content information through a network interface with an I-DVD player 100ₖ (e.g., via the Internet). When a user is provided with new content information, the user may choose to playback the information along with A/V data stored on an I-DVD disk in an I-DVD player 100ₖ. The I-DVD player 100ₖ, in one embodiment, searches for and verifies access information (e.g., URL) recorded and stored in the I-DVD disk. Then the I-DVD player 100ₖ performs, for example, a remote access operation for accessing a content server 300 (S10), as illustrated in FIG. 5. For example, a URL address may be submitted to request access to content information stored on a content server accessible via the internet.

The I-DVD player 100ₖ performs a series of initial operations to transmit a Disc ID identifying the I-DVD and content version information of the I-DVD disk to the content server 300 (S11). In some embodiments, the I-DVD player 100ₖ transmits the presentation time stamp (PTS) indicating the presentation start time of the A/V data. Included may be also, a request content information associated with the playback time information (S12). In certain embodiments, time information is embedded in the header field of a Packetized Elementary Stream (PES) stored in an I-DVD, for example, as illustrated in FIG. 6.

The PTS is time information associated with the A/V data presentation of an accessed resource. A Presentation Start Code (PSC) is recorded in the payload of a corresponding PES packet. The content server 300, upon receiving a request, searches for content information associated with the requesting I-DVD player based on the Disc ID and the content version information that are transmitted from the I-DVD player.

In accordance to one or more embodiments, the content server 300 references the PTS information of the I-DVD that are transmitted from the I-DVD player 100ₖ to extract the content information that relates to the PTS information as playback time information. Then, the content server 300 performs a series of operations to transmit the corresponding content information to the requesting I-DVD player (S13).

Accordingly, the I-DVD player after receiving the new content information associated with the PTS information plays back the A/V data and the content information of the I-DVD. The content information can be transmitted with video or audio data that corresponds to various products or advertising information relating to the content of the I-DVD, for example. The PTS information can set the A/V data to play back, for example, ahead of the actual display time, by considering the time that is required to download the content information from a content server onto an I-DVD player.

In some embodiments, the transmission request for the content information can be either submitted repeatedly at a predetermined time interval, or requested in real-time according to the playback operation of the A/V data. Further, the content provider operating the content server 300 can playback product information or advertisements along with the A/V data, for example. The above described content information playing method in an I-DVD player allows a user who is equipped with an I-DVD player to watch a variety of content information along with A/V data.

As such, a system and method for playing back A/V data along with related additional information is provided. While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method of playing interactive content information using a content medium player, the method comprising:
retrieving playback time information of first content information recorded on a recording medium playable in a content medium player;
transmitting the playback time information to a content server in communication with the content medium player via a communication network;
receiving second content information corresponding to the first content information from the content server; and
playing back the second content information along with the first content information, based on said playback time information.

2. The method of claim 1, wherein said playback time information is a presentation time stamp that indicates the play start time of the first content information.

3. The method of claim 1, wherein said playback time information is a presentation time stamp that is earlier than the play start time of the first content information by a predetermine period.

4. The method of claim 3, wherein the predetermined time period is approximately equal to length of time needed to receive the second content information from the content server.

5. The method of claim 1, wherein the second content information comprises advertising information associated with the first content information.

6. The method of claim 1, wherein the second content information is received from the content server at predetermined time intervals.

7. The method of claim 1, wherein the second content information is received from the content server in real-time in accordance with the playback time information associated with the first content information.

8. A content information playback method for a content server in communication with at least one content medium player connected to a communications network, the method comprising:
determining playback time for first content information, said playback time received from a content medium player player;
retrieving second content information associated with the first content information; and
transmitting the second content information to the content medium player for playback in association with the first content information.

9. The method of claim 8, wherein the step of determining a playback time comprises receiving a presentation time stamp (PTS) from the content medium player, wherein the PTS indicates time when playback of the first content information starts.

10. The method of claim 9, wherein the first content information comprises audio/visual (A/V) data recorded on a recording medium readable by the content medium player.

11. A system for playback of media content information using a content medium player connected to a content server via a communications network, the system comprising:
means for accessing a database over the communications network, wherein the database comprises access information about location of auxiliary content associated with the media content played by the content medium player; and
means for transmitting the auxiliary content to the content medium player so that the auxiliary content can be played along with the media content;
wherein said access information is obtained based on at least one of a disk ID and a content version associated with a recording medium containing the media content.

12. The system of claim 11, wherein the auxiliary content is stored on the content server.

13. The system of claim 12, wherein the access information comprises a Uniform Resource Locator (URL) identifying the content server.

14. The system of claim 11, wherein at least one of the disk ID and the content version are transmitted from the content medium player to the content server, so that the content server can determine the auxiliary content associated with the media content based on corresponding information included in the database.

15. The system of claim 14, wherein the database comprises an association between a plurality of disk Ids and content versions, such that each disk Id in association with a content version corresponds to auxiliary content for the respective content version.

16. The system of claim 11, further comprising:
means for transmitting a presentation time stamp to the content server, wherein the presentation time stamp is recorded in the recording medium.

17. The system of claim 16, wherein the presentation time stamp represents approximate time when the content medium player starts playback of the media content.

18. The system of claim 16, wherein the presentation time stamp represents approximate time needed to download the auxiliary data in advance of time when playback of the media content starts.

19. The system of claim 16, wherein the time stamp is transmitted embedded in a header of a communication packet.

20. The system of claim 11, wherein the media content is audio/visual (A/V) data.

21. An content medium player system for playback of media content, the system comprising:
means for accessing a content server comprising auxiliary content associated with the media content recorded on a recording medium readable by an content medium player;
means for transmitting identification information to retrieve said auxiliary content from the content server;
means for receiving the auxiliary content from the content server; and
means for playing the auxiliary content along with the media content in accordance with a presentation time stamp.

22. The content medium player system of claim 21, further comprising:
means for transmitting the presentation time stamp to the content server to ensure timely receipt of the auxiliary content prior to time when playback of the media content starts.

23. A content server system for providing auxiliary content recorded on the content server for playback with media content recorded on a recording medium readable by an content medium player, the system comprising:
means for receiving identification information associated with the auxiliary content from the content medium player over a communications network; and
means for transmitting the auxiliary content to the content medium player; wherein the content medium player plays back the auxiliary content along with the media content, inaccordance with a presentation time stamp.

24. The content server system of claim 23, further comprising:
means for receiving the presentation time stamp from the content medium player, the presentation time stamp indicating time when the content medium player starts playing the media content; and
means for transmitting the auxiliary content to the content medium player in a timely fashion, so that the content medium player starts playing the auxiliary content along with the media content.

25. The content server system of claim 24, wherein the media content is A/V data.

26. The content server system of claim 24, wherein the auxiliary content is advertisement material associated with the A/V data.
